(19) United States
(12) Patent Application Publication
(10) Pub. No.: US 2009/0019700 A1
(43) Pub. Date: Jan. 22, 2009

(54) DUAL PURPOSE RAZOR BLADE

(76) Inventor: Yaniv SHUSHAN, Petach Tikva (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/778,843

(22) Filed: Jul. 17, 2007

(51) Int. Cl. B26B 21/12

(52) U.S. Cl. 30/31

(57) ABSTRACT

A dual purpose razor blade comprising a substantially V-shaped detachable gauge attached to a disposable shaving razor. The gauge comprises two inclined surfaces creating a lip. The lip has a plurality of openings going thorough it creating a comb-like effect. The blade is positioned in close proximity to the openings in the lip, wherein the line of the blade is substantially parallel to the lip and further positioned substantially in the middle of the openings. Whenever the lip of the gauge is stroke against hair, only the hair that enters the openings meets the blade and is consequently being cut. Thus hair thinning effect is achieved. Detaching the gauge leaves the user with a regular shaving razor, both shaving and hair thinning in the same device.

### FIELD OF THE INVENTION

The present invention generally relates to razor blades and more specifically, to razor blades that enable hair thinning.

### BACKGROUND OF THE INVENTION

Combs with a razor blade inserted within the teeth of the comb are well known in the art in order to achieve hair thinning effect. According to hair thinning combs, the razor blade is positioned so that the line of the blade is substantially parallel to the line of teeth. In addition, the line of the blade is positioned substantially in the middle of the comb's teeth. Then, by stroking the comb, only the hair that enters the openings between the teeth meets the blade and is cut consequently.

Regular disposable razor blades are also very common in the art. They come in a variety of forms and sizes and are usually designed to adapt ergonomically for the required use.

However, combining the two devices is not known in the art. Sometimes a hair stylist requires the use of both a shaving razor and a hair thinning comb. Moreover, hygiene standards require the use of disposable blades. Therefore, it would be advantageous to have a disposable device that enables both shaving and hair thinning.

### SUMMARY OF THE INVENTION

The present invention suggests using a substantially V-shaped detachable gauge to be attached to a disposable shaving razor. The gauge comprises two inclined surfaces creating a lip. The lip has a plurality of openings going thorough it creating a comb-like effect. The blade is positioned in close proximity to the openings in the lip, wherein the line of the blade is substantially parallel to the lip and further positioned substantially in the middle of the openings. Whenever the lip of the gauge is stroke against hair, only the hair that enters the openings meets the blade and is consequently being cut. Thus hair thinning effect is achieved. Detaching the gauge leaves the user with a regular shaving razor, enabling both shaving and hair thinning in the same device.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1A is a side view of the dual purpose razor blade with the gauge detached, according to the present invention;

FIG. 1B is a side view of the dual purpose razor blade with the gauge attached, according to the present invention;

FIG. 2 is a side view of the dual purpose razor blade with the gauge detached showing the rails for detachment, according to the present invention; and

FIG. 3 is an elevated view of the gauge according to some embodiments of the invention.

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

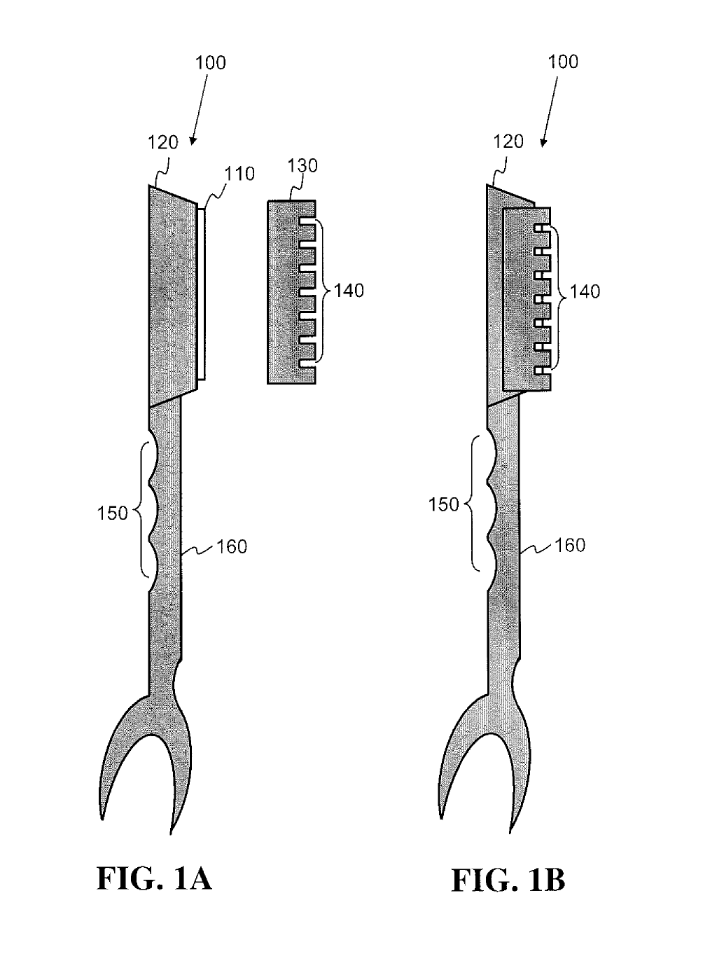

FIG. 1A is a side view of the dual purpose razor blade showing the gauge detached, according to the present invention. The dual purpose razor blade 100 comprises a razor blade 110 attached to a handle member 160. Specifically, the razor blade 110 is positioned within a blade holder 120, which may be integrated with the handle member 160 to form one piece. The handle member 160 may have several curves 150 to improve finger grip. The dual purpose razor blade 100 further comprises a detachable razor blade gauge 130 attached to said handle member 160 and partially wrapping said razor blade 110. The detachable razor blade gauge 130 is fitted with openings along its lip corresponding the unwrapped parts of razor blade 110 so that it creates a comb-like structure. The detachable razor blade gauge 130 enables selective access to said razor blade 110, and upon striking said gauge over hair, the hair is being thinned. The dual purpose razor blade 100 is designed so that detaching said gauge 130 enables using the razor blade as a regular razor blade for shaving hair.

FIG. 1B is a side view of the dual purpose razor blade 100 with the gauge 130 attached, according to the present invention. As it may be apparent from the drawing, the line of the blade 110 does not align with the lip of the gauge 130. Rather, it is positioned approximately 2-3 mm inwards, thus creating a hair thinning device effect.

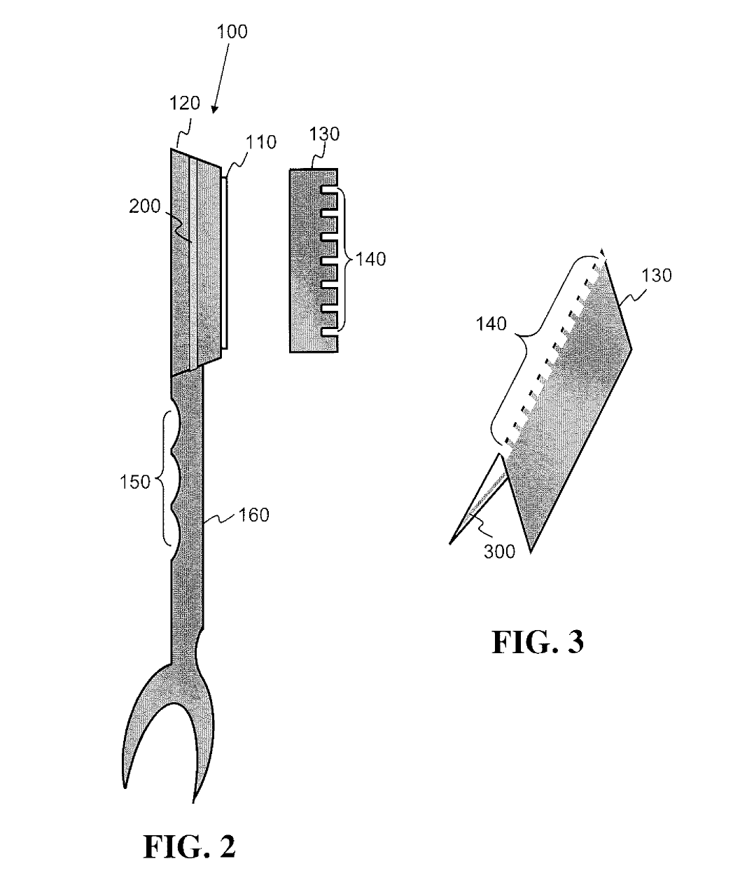

FIG. 2 is a side view of the dual purpose razor blade 100 with the gauge 130 detached showing the rails for detachment, according to the present invention. Specifically, parallel notches 200 are curved in both sides of the blade holder to enable quick detachment and subsequently attachment of the gauge 130. In this manner, the dual purpose razor blade 100 may be used in an alternating manner.

FIG. 3 is an elevated view of the gauge 130 according to some embodiments of the invention. The gauge 130 comprises two inclined surfaces crating a lip between them. The lip has a plurality of opening through it, creating a comb-like structure. Specifically the gauge 130 may have rails 300 positioned on the inner side s of the gauge 130. The rails 300 are aligned with the said notches 200. This enables a user to simply slide the gauge sideways, revealing the razor blade in full, so that tit may be used for shaving.

According to some embodiments of the invention the razor blade gauge 130 comprises two inclined surfaces creating a lip. The lip has a plurality of openings 140 through which the blade is accessible for selectively cutting hair. Specifically, the two inclined surfaces connected through a lip create a v-shaped cross section.

According to some embodiments of the invention the openings in the lip are substantially rectangular, but may be of any shape and size.

According to some embodiments of the invention, the razor blade gauge is attached to the handle member so that the line of the razor blade is substantially parallel to the lip.

According to some embodiments of the invention the razor blade gauge is positioned so that the line of the blade is between the lip and the end of the openings.

According to some embodiments of the invention the razor blade gauge is positioned so that the line of the blade is substantially half way between the lip and the end of the openings.

According to some embodiments of the invention the razor blade gauge is attached to the handle member via breakable connectors.

According to some embodiments of the invention the razor blade gauge is attached to the handle member by two rails connected to the gauge, wherein said rails are fitted into notches engraved in said handle. Detaching said gauge is performed by sliding the gauge along the notches.

According to some embodiments of the invention The dual purpose razor of comprising the handle member and the gauge is made from one piece of molded substance.

According to some embodiments of the invention the dual purpose razor is made from hardened polymer, plastic or any other polymer.

According to some embodiments of the invention the dual purpose razor further comprises a comb attached the handle member on the side opposite to the gauge.

According to some embodiments of the invention the dual purpose razor further comprises a brush attached the handle member on the side opposite to the gauge.

According to some embodiments of the invention the dual purpose razor is ergonomically designed to be used in hair styling applications.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A dual purpose razor blade comprising:
a razor blade; attached to
a handle member;
a detachable razor blade gauge attached to said handle member and partially wrapping said razor blade;
wherein said gauge enables selective access to said razor blade, and upon striking said gauge over hair, the hair is being thinned;
and wherein detaching said gauge enables using the razor blade for shaving hair.

2. The dual purpose razor of claim 1 wherein the razor blade gauge comprises two inclined surfaces creating a lip; wherein said lip has a plurality of openings corresponding to the unwrapped parts of the blade through which the blade is accessible for selectively cutting hair.

3. The dual purpose razor of claim 2, wherein the two inclined surfaces connected through a lip create a v-shaped cross section.

4. The dual purpose razor of claim 2, wherein the openings are substantially rectangular.

5. The dual purpose razor of claim 1, wherein the razor blade gauge is attached to the handle member so that the line of the razor blade is substantially parallel to the lip.

6. The dual purpose razor of claim 5, wherein the razor blade gauge is positioned so that the line of the blade is between the lip and the end of the openings.

7. The dual purpose razor of claim 5, wherein the razor blade gauge is positioned so that the line of the blade is substantially half way between the lip and the end of the openings.

8. The dual purpose razor of claim 1, wherein the razor blade gauge is attached to the handle member via breakable connectors.

9. The dual purpose razor of claim 1, wherein the razor blade gauge is attached to the handle member by two rails connected to the gauge, wherein said rails are fitted into notches engraved in said handle; and wherein detaching said gauge is performed by sliding the gauge along said notches.

10. The dual purpose razor of claim 1, wherein the handle member and the gauge are made from one piece of molded substance.

11. The dual purpose razor of claim 10, wherein said substance is hardened polymer.

12. The dual purpose razor of claim 1, further comprising a comb attached the handle member on the side opposite to the gauge.

13. The dual purpose razor of claim 1, further comprising a brush attached the handle member on the side opposite to the gauge.

14. The dual purpose razor of claim 1, ergonomically designed to be used in hair styling applications.
